(19) United States
(12) Patent Application Publication
(10) Pub. No.: US 2004/0131024 A1
(43) Pub. Date: Jul. 8, 2004

(54) Method and hierarchical radio network operations system for controlling a mobile communications network

(76) Inventor: Carlos Manzanares, Tampere (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/347,383

(22) Filed: Jan. 21, 2003

Related U.S. Application Data
(60) Provisional application No. 60/438,503, filed on Jan. 8, 2003.

(51) Int. Cl. H04Q 7/00; H04L 12/28

(52) U.S. Cl. 370/328; 370/408

(57) ABSTRACT

The invention relates to a hierarchical radio network operations system (OS) and a method for controlling a mobile communications network by a hierarchical radio network OS, the hierarchical radio network OS comprising at least one radio network OS on a subordinate level and a radio network OS on a superior level, wherein after a controlling action is initiated a demand for data depending on the controlling action is forwarded from the superior level OS to at least one subordinate level OS. The latter in response to the call forwards the demanded data to the radio network OS on the superior level.

### CROSS REFERENCE TO RELATED APPLICATION

This application claims the benefit of the filing date of provisional application ______ (Attorney Docket No. 1120.42308L00) entitled Method and Hierarchical Radio Network Operations System For Controlling A Mobile Communication Network which was filed on Jan. 8, 2003, and which is incorporated herein by reference in its entirety.

### BACKGROUND OF THE INVENTION

Field of the Invention

The present invention relates to a hierarchical radio network operations system (OS) and a method for controlling a mobile communications network by a hierarchical radio network OS, the hierarchical radio network OS comprising at least one radio network OS on a subordinate level, also referred to as subordinate network, and a radio network OS on a superior level, also referred to as superior network.

Configuration Management (CM), as specified by the third generation partnership project (3GPP), in general, provides an operator of a 3G mobile communications network (hereafter 3G network) with the ability to ensure correct and effective operation of the network. CM actions, also referred to as controlling actions, either initiated by the operator or by functions in an operations system (OS), have the objective to control and monitor the actual configuration on network elements (NEs) and network resources (NRs). Herein the NR denotes a component of a NE which can be identified as a discrete separate entity in an object oriented environment. The NR itself and, consequently, the NE is represented by an abstract entity, the so-called managed object (MO). CM actions may be requested as part of an implementation programme (e.g. additions and deletions on a 3G network), as a part of an optimisation programme (e.g. modifications), and to maintain the overall quality of service (QOS). The CM actions are initiated either as single actions on single NEs of the 3G network, or as part of a complex procedure involving actions on many resources/objects in one or several NEs. They are executed by a set of controls defined in the 3GPP technical specification (TS) 32.600. According to this specification the management of a network is accomplished by a package of end-user functions, provided by the so-called network manager (NM). The NM is supported by an element manager (EM) in turn providing a package of end-user functions for management of a set of closely related types of NEs.

According to another 3GPP-technical specification, TS 32.102, the communication between the NM and the NE via the EM or via direct access is based on an open standardized interface (Itf-N). The Itf-N is an object oriented interface, i.e. all resources of the 3G network whose management is standardized are represented as managed object instances (MOI) of a network resource model (NRM).

However, the CM is addressed to the management of 3G networks on a regional level only, i.e. it defines the specifications for internally controlling a radio network supported by a single provider. Whereas, in future, operators should be able to control radio networks on a higher level, that is to say initiating controlling actions on the part of the superior radio network OS affecting one or a plurality of radio networks on the regional level, e.g. GSM networks or/and 3G networks. Therefore, data necessary for controlling the regional radio networks, e.g. managed objects, managed objects parameters and their values, have to be synchronized between the radio network OSs on the regional level and the radio network OS on the superior level. Whereas, according to the above specifications, the regional radio network OS has an accurate and up to date picture of how the actual radio network is set up there is presently no such specification facilitating a configuration management on a superior level, e.g. provisioning and changing radio network parameters of neighbouring radio network cells supported by different manufacturer's equipment and supported by different providers at the same time.

Recently, a configuration management project, so-called mobile common configuration management (MCCM), was developed showing how mobile network operators can provision and change radio parameters for all affected GSM and UMTS cells supported by different providers using a flow-through process controlled by a single tool. The proposed MCCM solution is based on a regular upload, e.g. of radio network parameter data from radio network OSs on a regional level to a radio network OS on a superior level. The upload operation thereby comprises the steps of regularly fetching radio network data from all regional radio network OSs stored in their regional data bases (DB), exporting these data by the regional radio network OS, importing the data by the superior radio network OS and storing these data in a data base on the superior level. For the exporting and importing action a Bulk CM interface is used which is a part of the standardized Itf-N interface mentioned above. For further details see 3GPP TS 32.600.

However, the regular upload solution proposed by the 3GPP MCCM architecture implicates that the superior radio network OS has to handle a huge amount of data within a short period of time. Thus, it requires an equipment with large memory and computing power. Since the loading time is a non-operative time the regional radio network OSs and the superior radio network OS, as well, are out of normal order for too long. Therefore, the loading operation reasonably can only be scheduled during night, i.e. once a day. Accordingly, the data is in average 12 hours old which may restrict the usability of the data for some applications or controlling actions. A further drawback of the 3GPP MCCM solution is that due to the huge amount of data, actually, not all data available in the radio network OS on regional level can be uploaded, so that a filtering process appears to be essential to reduce the amount of data to a reasonable volume. Consequently, only a subset of managed object parameters and their values are available for controlling or managing the radio networks restraining the controlling actions and controlling functions available for the superior radio network OS. Therefore, management tools available for radio network OSs on the regional level provided by respective vendors suffer losses in functionality or can not at all be used on the superior level.

### SUMMARY OF THE INVENTION

Therefore, it is an object of the present invention to provide a hierarchical radio network OS and a method for controlling a mobile communications network by a hierarchical radio network OS which overcomes the aforementioned drawbacks, particularly, which provides an up-to-date picture of the regional radio networks.

It is a further object of the present invention to provide a hierarchical radio network OS and a method for controlling a mobile communications network by a hierarchical radio network OS wherein the computer load in the regional networks OSs and the computer load and the memory consumption in the superior radio network OS is reduced. Thus, the cost for the superior radio network OS can be reduced.

It is a third object of the present invention to provide a hierarchical radio network OS and a method for controlling a mobile communications network by a hierarchical radio network OS which reduces the non-operative time of the participating superior and subordinate radio network OSs.

A fourth object of the present invention is to provide a hierarchical radio network OS and a method for controlling a mobile communications network by a hierarchical radio network OS that maximizes the reusability of the controlling applications already developed for the regional radio network OSs also for the superior radio network OS.

These objects are achieved by a method for controlling a mobile communications network by a hierarchical radio network operations system with at least one radio network operations system on a subordinate level and a radio network operations system on a superior level comprising the steps of initiating a controlling action on the part of the radio network operations system on the superior level, generating a call for data depending on the controlling action, forwarding the call to at least one of the radio network operations systems on the subordinate level affected by the controlling action, providing data on the part of the radio network operations systems on the regional level affected by the controlling action in response to the call, and forwarding the data to the radio network operations system on the superior level. Preferrably, the controlling action is executed on the basis of the retrieved data.

Accordingly, this object is achieved by a hierarchical radio network operations system for controlling a mobile communications network, the hierarchical radio network operations system comprising at least one radio network operations system on a subordinate level, a radio network operations system on a superior level, initiating means being part of the radio network operations system on the superior level arranged for initiating a controlling action, call generating means arranged for generating a call for data depending on the controlling action, forwarding means arranged for forwarding the call to at least one of the radio network operations systems on the subordinate level affected by the controlling action, first providing means being part of the radio network operations system on the subordinate level arranged for providing data in response to the call, and second forwarding means being arranged for forwarding the data to the radio network operations system on the superior level. Preferrably, the hierarchical radio network OS further comprises executing means arranged for executing the controlling action on the basis of the retrieved data.

Controlling herein means e.g. modifying, monitoring the actual set-up and/or planning a future set-up of one or several mobile communication networks. Thus, the controlling action based on the retrieved data can either be executed on the part of the superior radio network OS, the subordinate radio network OS or both.

The radio network OS on the subordinate level preferably is a regional radio network OS for managing operator's mobile network regions such as operator's GSM networks or 3G networks for example, but may also be any other even higher ranking OS. Preferably, the hierarchical radio network operations system according to the invention comprises a plurality of such subordinate radio network OSs and one superior radio network OS.

The method and system according to the invention overcomes the above-mentioned problems directly accessing the actual data from the regional radio network OSs, by generating a specific call for data. Namely, the call is generated in response to a controlling action initiated e.g. by the operator or by functions of the superior radio network OS. Consequently, it is possible to fetch data from regional radio network OS only of those radio networks which are affected by the controlling action. In other words the remote calls from the superior radio network OS are made only on demand. As a result, the data transfer to the superior network OS occurs on demand, too. Thereby, the dataflow is reduced to an amount actually requested reducing the performance requirements for controlling actions and the non-operative time for controlling actions in the total hierarchical radio network OS.

Since the data can be forwarded directly without filtering from the regional network OSs to the superior network OS the same management applications can be applied in both levels.

### BRIEF DESCRIPTION OF THE DRAWINGS

The above and other objects, features and advantages of the present invention will become apparent from the following description of preferred embodiments thereof taken in conjunction with the accompanying drawings in which

FIG. 1 shows a flow diagram of a first embodiment of the method and OS according to the present invention;

FIG. 2 shows a flow diagram of a second embodiment of the method and OS according to the present invention;

FIG. 3 shows a schematic partial illustration of the second embodiment of the OS according to the present invention; and

FIG. 4 shows schematic illustration of an OS according to a further embodiment of the present invention.

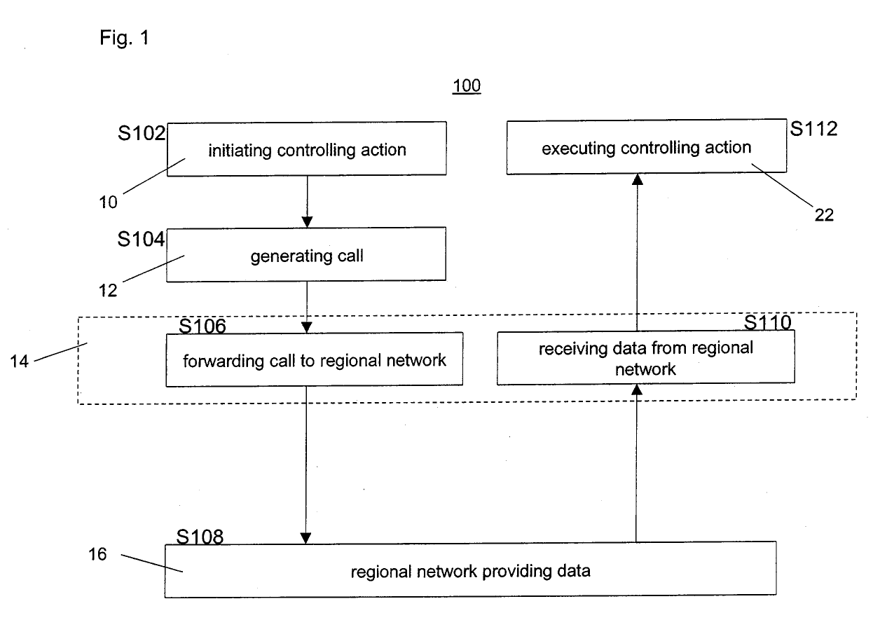

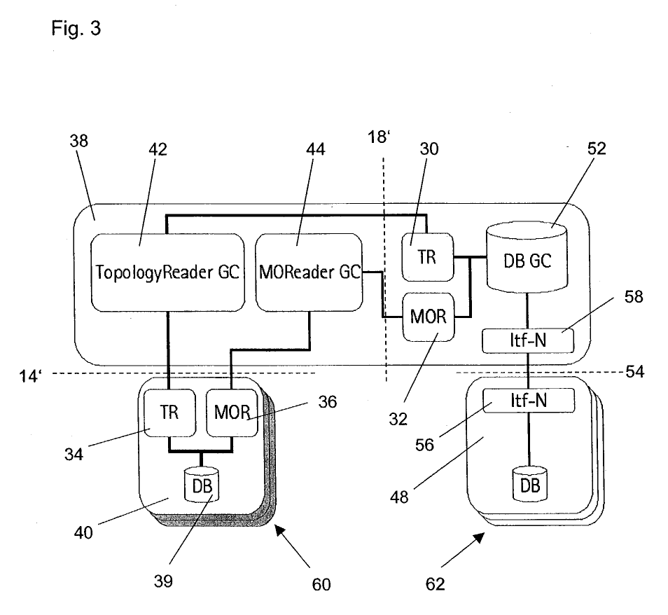

A first preferred embodiment of a hierarchical radio network OS 100 and a method for controlling a mobile communications network by a hierarchical radio network OS 100 according to the present invention illustrated in FIG. 1 applies to the most simple case when communication between the regional radio network OS(s) (only one regional OS is exemplified) and the superior radio network OS proceeds via an unified interface described in more detail below in conjunction with FIG. 3. In this case, when in a first step S102 the operator or functions in an operations system in the superior network initiates via initiating means 10 a controlling action a call is generated in step S104 by call generating means 12 requesting for data. These data are typically MO parameters and MO parameter values required for the execution of the controlling action. The call is addressed to those radio network OS(s) on the regional level which are affected by the controlling action whereby the call generating means 12 implement a unified interface 20. Thus, in step S106 the call is forwarded by first forwarding means 14 to respective regional network OS(s), only. The regional network OS(s) receiving the call then provide the requested data which are stored in regional DBs (not shown in FIG. 1) in step S108 by first providing means 16. The data are forwarded in step S110 by second forwarding means 18 via the same unified interface 20 back to the superior radio network OS. There, the controlling action is executed in step S112 based on the received actual data by executing means 22 such as management applications for example. The controlling action can in addition be based on planned data retrieved e.g. from a DB belonging to the superior radio network OS or from one or a plurality of DBs belonging to any of the regional radio network OSs affected by the controlling action. In this way, the data stored in the regional OSs providing an accurate and up to date picture of how the actual radio networks are set up in the particular regions are available on demand also for the superior radio network OS.

However, in a more complicated case the data may not be directly accessible from each regional network OS either because of a lack of compatibility, e.g. the aforementioned interface is not supported by respective regional network OS, or because the response time of the addressed regional radio network OS is too high due to a high customer's data communication network (DCN) latency. If so, according to a second preferred embodiment of the invention data storing means, also referred to as data base (DB), being part of the superior level OS are arranged for storing network data of at least one predetermined regional radio network received in a regular upload method as suggested by the MCCM solution mentioned above. The decision whether or not regional network data are to be stored in the superior database via regular upload as well as the decision whether a call for data is to be forwarded to the appointed regional network OS or to the superior DB will preferably be made in advance, e.g. by a system manager.

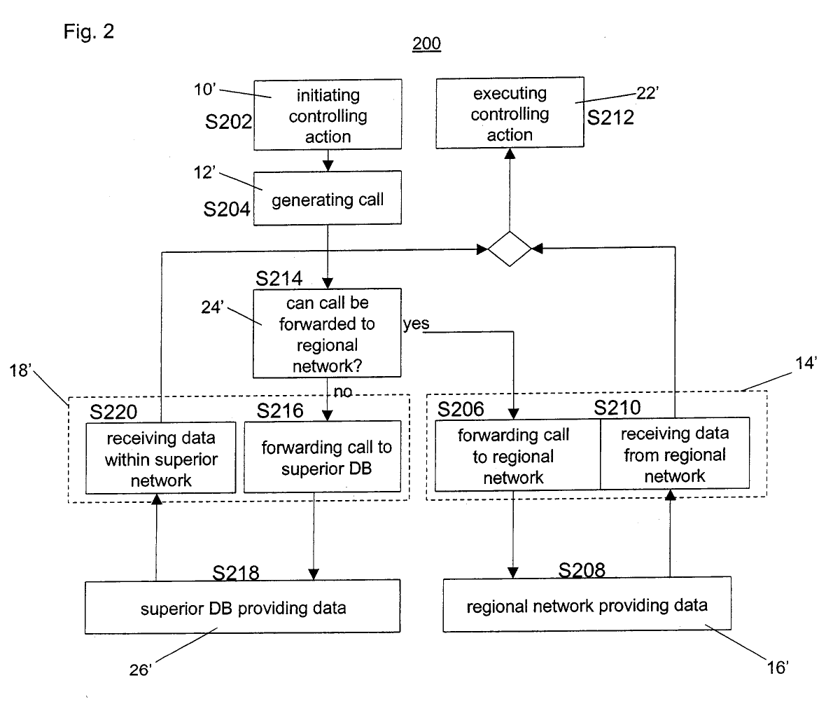

Therefore, the second preferred embodiment of the present invention as illustrated in FIG. 2 will preferably be applied to a hierarchical radio network OS comprising at least one regional network OS not being directly accessible via said unified interface. According to this embodiment a device 200 for controlling a hierarchical radio network OS comprises first ascertaining means 24 within the superior radio network OS for ascertaining in step S214 whether the call generated in steps S202, S204 in the same manner as described in conjunction with FIG. 1 above (S102, S104) is to be forwarded to the regional radio network OS(s) it is addressed to. Ascertaining in this regard, for example, may mean retrieving whether or not a flag is set by a system manager indicating that the call is not to be forwarded to the regional network OS(s) due to a lack of compatibility and/or due to a high DCN latency. Instead of a flag set by a system manager the superior network can also be fixedly set up. The set up typically executed during the installation of the superior network OS or during the integration of a subordinate OS then includes a configuration file providing information how to fetch data from each regional network connected to the superior network. The respective decisions have to be made in advance. In that case, the ascertaining means simply determine the parameters set in the configuration file.

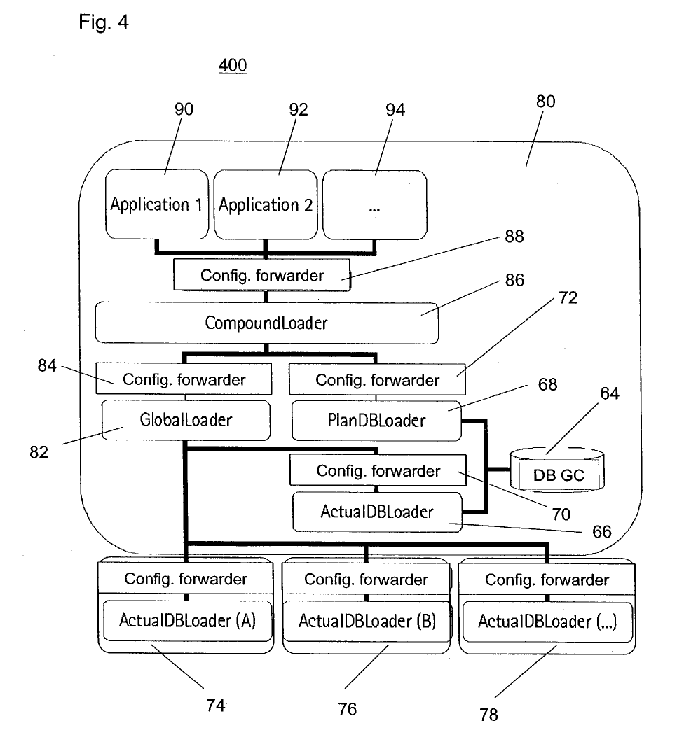

If a call for data is not to be forwarded to the regional radio network OS(s) it is addressed to the call is forwarded in step S216 by first forwarding means 14′ to second providing means 26 belonging to the superior radio network OS. The second providing means 26 typically comprise a loader for reading out data contained in said superior DB, not shown in FIG. 2, for this see FIG. 4. Then, the requested network data are provided in step S218 by the second providing means 26 on the part of the superior radio network OS. Consequently, the data are forwarded in step S220 by third forwarding means 28 within the superior radio network OS to the executing means 22′ for executing in step S212 the controlling action based then on the regularly uploaded data, thereby accepting the drawbacks mentioned above.

In the other case, i.e. when a call for data are to be forwarded to the regional radio network OS it is addressed to, the call is forwarded in step S206 by said first forwarding means 14′ to said regional radio network OS(s). This step and the following steps S208, S210, S212 take place according to the method as described in conjunction with FIG. 1: first Providing means 16′ provide the retrieved data which are forwarded via the unified interface 20′, particularly, by the second forwarding means 18′ to the executing means 22′.

If the ascertaining means 24 ascertain in step S214 that the call is to be forwarded to the regional radio network OS(s) and as, however, the case arises that the latency is too high in a further embodiment of the present invention second ascertaining means (not shown in figures) may be provided within the superior network OS ascertaining after step S214 whether or not the demanded data can be received from the appointed regional radio network OS(s) within a predetermined latency. Accordingly, an additional decision whether or not the call for data is to be forwarded to an appointed regional network is made in real time by the superior radio network OS itself. If the response time is too high, that is if the data can not be received within the predetermined latency the call will again be forwarded by said first forwarding means 14′ in a next step to said second providing means 26. In the same manner as described above the second providing means 26 will provide the retrieved data which are forwarded by said third forwarding means 28 within the superior network OS for finally executing the controlling action by executing means 22′ such as management applications, for example. If the data can be received within the predetermined latency in step S208 the next steps comply with steps S210 and S212.

The second embodiment of the present invention described in conjunction with FIG. 2 is partially illustrated in more detail in FIG. 3. According to this embodiment the forwarding means 14′, 18′, 28 are split in two parts. Each of them comprise topology reader 30, 34, 42, respectively, and managed object reader 32, 36, 44, respectively. The demand for data generated in the manner described above will be forwarded via interface 20′ either by topology readers 42, 34 or by MO readers 44, 36 to that regional network OSs 60 to which it is addressed, in the illustrated example to DB 39 of regional network OS 40. That is to say, the topology reader 42 when it forwards the call invokes the topology reader 34 installed in the regional network OS 40. The MO reader 44 when it forwards the call invokes the MO reader 36 in the regional network OS 40.

If regional network OSs 62 other than the network OSs 60 do not support the unified interface 20′, e.g. regional network OS 48, the forwarding means 42, 44 will forward the demand for data via interface 20′ either by the topology readers 42, 30 or the managed object readers 44, 32 in response to the output result of the first ascertaining means 24, not shown in FIG. 3. In this case the data will be received from a database (DB) 52. In particular these data are provided by a DB loader (not shown) for readout of data from DB 52 within the superior network OS 38.

The data stored in DB 52 are typically updated once a day during night. This regular update process is communicated via the aforementioned Iff-N interface 54 described in the introductory part of the present document. Data retrieved by the DB 52, particularly by retrieving means not explicitly shown FIG. 3, are exported by exporting means 56 on the regional level and then imported by importing means 58 on the side of the superior level. Both, exporting means 56 and importing means 58 implement the Bulk CM part of the above-mentioned Itf-N interface. Subsequently, the data are stored in the DB 52.

The method and OS according to the second embodiment of the present invention, thus, differentiates between two kinds of regional network OSs: firstly regional network OSs 60 which are able to communicate data on demand using the interface 20′, and such regional network OSs 62 which are not able to communicate data on demand, therefore, using the regular upload interface 54 as suggested by MCCM. Nevertheless, the method and OS according to the second embodiment of the present invention allows the communication within the hierarchical radio network operations system comprising both kinds of regional radio network OSs. It is sort of an universal controlling method and device. It further allows to apply in a simple manner the same CM tools in the superior radio network OS 38 and in the regional network OSs 60 in so far data are communicated via interface 20′. Thus, the invention overcomes the aforementioned problems at least accessing directly the actual data stored in the regional network OSs 60 and providing it in its entirety. With regard to these regional networks OSs 60 no unnecessary load to the superior radio network OS 38 due to export/import operations is generated. The computing load and memory consumption is distributed across these regions 60 so that system hardware does not require a different dimensioning in the superior network OS 38 compared with the regional network OSs 60.

The hierarchical OS 400 schematically shown in FIG. 4 exemplifies how the invention can be applied to a specific set of data stored in a DB 64 on the superior level for management of a mobile communications network. Namely, according to this embodiment the set of data contains actual data representing the actual status of regional networks not able to communicate via the unified interface and plan data representing information on the planned configuration. Thus, it differs from the device shown in the previous figures by comprising separate means for providing and forwarding actual data and plan data, respectively.

In particular, DB 64 being part of data storing means in the superior network OS 80 is arranged for storing actual data of regional data bases not able to communicate via said unified interface as well as for storing plan data. Connected to the DB 64 one can find an actual data DB loader 66 as second providing means and a plan data DB loader 68 as third providing means. Both providing means implement third forwarding means 70 and fourth forwarding means 72, respectively, both communicating via said unified interface. Actual data stored in the DB 64 in the superior network OS 80 as well as actual data stored in distributed data bases in regional network OSs 74, 76, 78, each being provided and forwarded via said unified interface in the manner described above are accumulated by a global loader 82 which provides these data implementing configuration forwarder 84. Whereby, configuration forwarder 84 communicates via said unified interface, too. In parallel, the plan data DB loader 68 provides plan data and implements the fourth forwarding means 72. A further providing means 86, the so called compound loader accumulates data forwarded by forwarders 72, 84 and provides the mixed actual and plan data to a further configuration forwarder 88 which is arranged to communicate with controlling applications 90, 92, 94 using the same unified interface standard. Thus, said interface is utilized throughout each level of the hierarchical radio network OS 400 shown in FIG. 4. Said data are collected on demand in order to execute one or several applications activated e.g. by an operator or an operating function in the superior radio network OS.

It is noted, that the present invention is not restricted to the above preferred embodiments but may be used for controlling a mobile communications network by a hierarchical radio network operations system of any other kind. In particular, the hierarchical radio network operations system may also comprise three or even more management levels. In particular, the radio network OS on a subordinate level according to any of the above embodiments may be an OS for controlling a regional radio network or may be a higher ranking OS. Moreover, the unified interface is not restricted to a subdivision as shown in FIG. 3. The providing means and forwarding means therein may be subdivided into three or more elements depending on the diversity of data to be handled. The unified interface may be conceived as an open interface offered for applications outside of CM applications, too. The invention can further be applied to sets of data other than a set comprising actual data and plan data as exemplified by FIG. 4.

1. A method for controlling a mobile communications network by a hierarchical radio network operations system with at least one radio network operations system on a subordinate level and a radio network operations system on a superior level comprising the steps of
initiating a controlling action on the part of the radio network operations system on the superior level,
generating a call for data depending on the controlling action,
forwarding the call to at least one of the radio network operations systems on the subordinate level affected by the controlling action,
providing data on the part of the radio network operations system on the subordinate level affected by the controlling action in response to the call, and
forwarding the data to the radio network operations system on the superior level.

2. A method for controlling a mobile communications network by a hierarchical radio network operations system according to claim 1 which further comprises the steps of
executing the controlling action on the basis of the retrieved data.

3. A method for controlling a mobile communications network by a hierarchical radio network operations system according to claim 1 which further comprises the steps of
retrieving data by the radio network operations system on the superior level from at least one of the radio network operations systems on the subordinate level,
exporting the retrieved data by the radio network operations system on the subordinate level,
importing the data by the radio network operations system on the superior level, and
storing the imported data to data storing means in the radio network operations system on the superior level.

4. A method for controlling a mobile communications network by a hierarchical radio network operations system according to claim 3 which further comprises the steps of
ascertaining whether the call for data demanded depending on the controlling action is to be forwarded to the radio network operations system on the subordinate level affected by the controlling action
forwarding the call for data to the data storing means when the call is not to be forwarded to the radio network operations system on the subordinate level,
providing data on the part of the data storing means in response to the call, and
forwarding the data within the radio network operations system on the superior level.

5. A method for controlling a mobile communications network by a hierarchical radio network operations system according to claim 4 which further comprises the steps of
ascertaining whether the data demanded depending on the controlling action can be received from the radio network operations system on the subordinate level affected by the controlling action within a predetermined latency, and
forwarding the call for data to the data storing means when the data can not be received within a predetermined latency before providing data on the part of the data storing means.

6. A method for controlling a mobile communications network by a hierarchical radio network operations system according to claim 1, wherein the controlling action comprises monitoring and controlling a configuration of radio network elements and/or radio network resources.

7. A method for controlling a mobile communications network by a hierarchical radio network operations system according to claim 1,
wherein the data demanded depending on the controlling action comprise network elements parameters and/or network resources parameters of the radio network on the subordinate level.

8. A method for controlling a mobile communications network by a hierarchical radio network operations system according to claim 1,
wherein the data demanded depending on the controlling action comprise topology data of the radio network on the subordinate level.

9. A method for controlling a mobile communications network by a hierarchical radio network operations system according to claim 1,
wherein said radio network operations system on a subordinate level is an operations system for managing a regional radio network.

10. A hierarchical radio network operations system for controlling a mobile communications network, the hierarchical radio network operations system comprising
at least one radio network operations system on a subordinate level,
a radio network operations system on a superior level,
initiating means being part of the radio network operations system on the superior level arranged for initiating a controlling action,
call generating means arranged for generating a call for data depending on the controlling action,
first forwarding means arranged for forwarding the call to at least one of the radio network operations systems on the subordinate level affected by the controlling action,
first providing means being part of the radio network operations system on the subordinate level arranged for providing data in response to the call, and
second forwarding means arranged for forwarding said data to the radio network operations system on the superior level.

11. A hierarchical radio network operations system for controlling a mobile communications network according to claim 10 which further comprises executing means arranged for executing the controlling action on the basis of the retrieved data.

12. A hierarchical radio network operations system for controlling a mobile communications network according to claim 10 which further comprises
retrieving means being part of the radio network operations system on the superior level arranged for retrieving data from at least one of the radio network operations systems on the subordinate level,
exporting means being part of the radio network operations system on the subordinate level arranged for exporting the retrieved data,
importing means being part of the radio network operations system on the superior level arranged for importing the data, and
data storing means being part of the radio network operations system on the superior level arranged for storing the imported data.

13. A hierarchical radio network operations system for controlling a mobile communications network according to claim 12 which further comprises
first ascertaining means being part of the radio network operations system on the superior level arranged for ascertaining whether the call for data demanded depending on the controlling action is to be forwarded to the radio network operations system on the subordinate level affected by the controlling action, said first forwarding means further being arranged for forwarding the call for data to the data storing means when the call is not to be forwarded to said radio network operations system on the subordinate level,
second providing means being part of the radio network operations system on the superior level arranged for providing data stored in the data storing means in response to the call, and
third forwarding means being arranged for forwarding the data within the radio network operations system on the superior level.

14. A hierarchical radio network operations system for controlling a mobile communications network according to claim 13 which further comprises second ascertaining means being part of the radio network operations system on the superior level arranged for ascertaining whether the data demanded depending on the controlling action can be received from the radio network operations system on the subordinate level affected by the controlling action within a predetermined latency, said first forwarding means further being arranged for forwarding the call for data to said data storing means when the data can not be received within a predetermined latency.

15. A hierarchical radio network operations system for controlling a mobile communications network according to claim 10 which further comprises
monitoring means arranged for monitoring configuration of radio network elements and/or radio network resources and
controlling means arranged for controlling configuration of radio network elements and/or radio network resources.

16. A hierarchical radio network operations system for controlling a mobile communications network according to claim 13
wherein said call generating means, said first to third forwarding means, and said first and second providing means are arranged for generating and forwarding a call for network elements parameters and/or network resources parameters of the radio network operations system on the subordinate level and for forwarding and providing said parameters.

17. A hierarchical radio network operations system for controlling a mobile communications network according to claim 13
wherein said call generating means, said first to third forwarding means, and said first and second providing means are arranged for generating and forwarding a call for topology data of the radio network operations system on the subordinate level and for forwarding and providing said topology data.

18. A hierarchical radio network operations system for controlling a mobile communications network according to claim 17
wherein said first to third forwarding means and said first and second providing means comprise topology reading means and managed object reading means.

19. A hierarchical radio network operations system for controlling a mobile communications network according to claim 10 which further comprises
second data storing means being part of the radio network operations system on the superior level arranged for storing planned data;
third providing means being part of the radio network operations system on the superior level arranged for providing said planned data, and
fourth forwarding means being arranged for forwarding said planned data within the radio network operations system on the superior level.

20. A hierarchical radio network operations system for controlling a mobile communications network according to claim 10
wherein said radio network operations system on a subordinate level is an operations system for managing a regional radio network.
